(19) United States
(12) Patent Application Publication
(10) Pub. No.: US 2019/0276159 A1
(43) Pub. Date: Sep. 12, 2019

(54) AVIONIC SYSTEM OPERATOR TERMINAL FLYING AN AIRCRAFT

(71) Applicant: THALES, Courbevoie (FR)

(72) Inventors: Fabien CAMUS, Pessac Cedex (FR); Olivier Regnault, Pessac Cedex (FR); Gilles Guerrini, Pessac Cedex (FR)

(21) Appl. No.: 16/284,994

(22) Filed: Feb. 25, 2019

(30) Foreign Application Priority Data
Mar. 6, 2018 (FR) 18 00195

(51) Int. Cl. B64D 43/00; G08G 5/00; G08G 5/04

(52) U.S. Cl. CPC B64D 43/00; G08G 5/045; G08G 5/0047

(57) ABSTRACT

The invention relates to an operator terminal of an avionic system for flying an aircraft, suitable for use during a mission including a plurality of mission phases, the operator terminal comprising at least a display module and a computing device, implementing a flight management system suitable for determining a reference trajectory of the aircraft by incorporating at least one environment constraint. This terminal is suitable for displaying, on the display module, the reference trajectory, a current position of the aircraft and a plurality of accessibility zones, at least one of the accessibility zones having an intersection with the reference trajectory, the accessibility zones having an associated calculated accessibility level, the accessibility level being defined as a function of a current mission phase, a trajectory predicted from the reference trajectory and at least one flight constraint associated with the current mission phase.

### FIELD OF THE INVENTION

The present invention relates to an operator terminal of an avionic system for flying an aircraft, an associated information display method and an associated avionic system, in the context of complex missions.

### BACKGROUND OF THE INVENTION

The invention falls within the field of securing aircraft flying, and is in particular applicable in the field of systems for conducting the flight and guidance of an aircraft performing a mission.

The term aircraft generally refers to any platform suitable for flying, with a pilot on board or remotely controlled, without a pilot on board, for example an airplane, a helicopter or a drone.

An aircraft mission may be military, in the context of tactical operations, or civilian, for example a supply mission or a search and rescue mission at sea. Unlike a planned flight for an airliner, for which flying is guided by an avionic system to follow a trajectory calculated beforehand, the missions assigned to aircraft capable of incorporating the invention consist of a sequence of phases of tasks of various natures.

For each of the mission phases, the crew uses different types of environment information. The term crew here refers to the person or people responsible for flying the aircraft.

At this time, various systems are known, called mission systems, that interact with a flight management system (FMS). Such mission systems use information supplied by on-board sensors and provide the FMS with the constraints it needs to calculate a trajectory considered to be optimal intended for the crew or the automatic pilot system. Such mission systems are very complex and use a very large quantity of information, and the crew is not informed in detail of the calculation done. As a result, it is difficult for the pilot to know the elements at the origin of the calculation of the trajectory, and to understand the construction thereof. As a result, the pilot also cannot evaluate the margin he has to follow the trajectory that is proposed to him.

Other mission systems make it possible to display a very large amount of information, but such a display is very cluttered and it is complex to interpret, whereas during a mission flight, the crew must make decisions very quickly. An overloaded display increases the mental load of the pilot(s) and does not promote secure flight conduct.

There is a need to improve mission flying information systems to help improve the acceptability of data from complex processing in avionic, security and crew risk anticipation systems.

### SUMMARY OF THE INVENTION

To that end, according to a first aspect, the invention proposes an operator terminal of an avionic system for flying an aircraft, suitable for use during a mission including a plurality of mission phases, the operator terminal comprising at least a display module and a computing device, implementing a flight management system suitable for determining a reference trajectory of said aircraft by incorporating at least one environment constraint. This system is suitable for displaying, on said display module, said reference trajectory, a current position of the aircraft and a plurality of accessibility zones, at least one of said accessibility zones having an intersection with said reference trajectory, said accessibility zones having an associated calculated accessibility level, the accessibility level being defined as a function of a current mission phase, a trajectory predicted from the reference trajectory and at least one flight constraint associated with the current mission phase.

Advantageously, the operator terminal of the invention displays accessibility zones around the predicted trajectory, the method for computing said accessibility zones being specific to each mission phase.

The operator terminal according to the invention may have one or more of the features below, considered independently or in combination, according to all technically acceptable combinations.

The display is done according to a display mode chosen according to a first display mode and a second display mode based on the current mission phase.

Each accessibility zone has an associated display characteristic representative of the accessibility level.

The display also includes a first graphic symbol, indicating a current position of the flown aircraft and a direction of flight of the aircraft, and at least one second graphic symbol, indicating a position of a second aircraft.

The display includes an alert display when the predicted trajectory crosses a zone with an accessibility level below a predetermined threshold.

The display is refreshed dynamically at regular time intervals.

The constraints associated with the current mission phase include at least one mandatory constraint and at least one relative constraint associated with the current mission phase.

According to another aspect, the invention relates to an avionic system for flying an aircraft suitable for use during a mission including a plurality of mission phases, the avionic system including an operator terminal as briefly described above connected to a device for flying the aircraft.

According to another aspect, the invention relates to a display method implemented by an operator terminal of an avionic system for flying an aircraft, suitable for use during a mission including a plurality of mission phases, the operator terminal comprising at least a display module and a computing device, implementing a flight management system suitable for determining a reference trajectory of said aircraft by incorporating at least one environment constraint. This method includes the following steps:
computing a predicted trajectory of the aircraft as a function of said reference trajectory, computing a plurality of accessibility zones, at least one of said accessibility zones having an intersection with said reference trajectory, said accessibility zones having an associated calculated accessibility level, the accessibility level being defined as a function of a current mission phase and at least one flight constraint associated with the current mission phase,
displaying, on a module of the operator terminal, the reference trajectory, a current position of the aircraft and said accessibility zones.

According to one embodiment, the calculation of accessibility zones comprises the following steps:
computing a three-dimensional envelope of the predicted trajectory, and obtaining a plurality of nodes representative of said envelope,
for each node, obtaining a plurality of associated constraints, as a function of the current mission phase, and calculating an accessibility level by a sum weighted by weight coefficients associated with said constraints, at least part of the weight coefficients depending on the current mission phase.

According to one embodiment, the method further includes a step for emitting an alert if said envelope contains a node whose calculated accessibility level is below a predetermined threshold.

According to one embodiment, the alert emission includes a display on the display module of an alert indicator and of information relative to at least one constraint applicable to said node.

### BRIEF DESCRIPTION OF THE DRAWINGS

Other features and advantages of the invention will emerge from the description thereof provided below, for information and non-limitingly, in reference to the appended figures, in which:

FIG. 1 is a schematic view of an avionic system according to one embodiment of the invention;

FIG. 2 is a schematic illustration of a display view according to a first display mode;

FIG. 3 is a schematic illustration of a display view according to a second display mode;

FIG. 4 is a flowchart of the main steps of a display method according to one embodiment.

### DETAILED DESCRIPTION OF EMBODIMENTS

The invention will be described in one embodiment of an avionic system for displaying information for flying an aircraft, comprising an operator terminal on board the aircraft.

Alternatively, the avionic system is distributed between on board and the ground, and the operator terminal is in a control center on the ground.

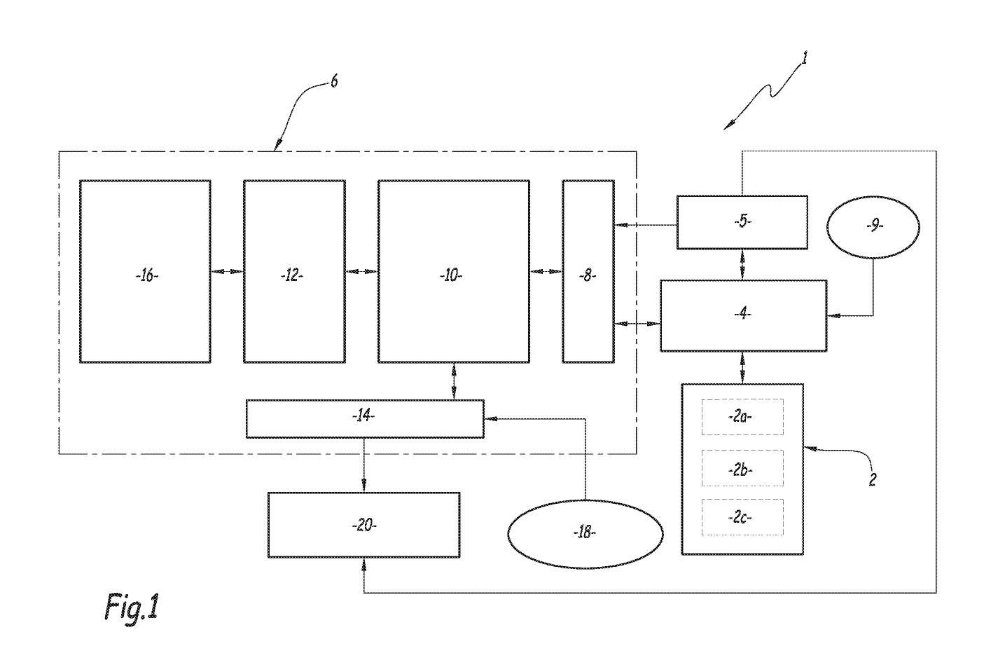

One example avionic system 1 according to the invention is illustrated in FIG. 1.

This avionic system 1 allows improved flying of an aircraft, not shown, during a mission.

The system 1 comprises a plurality 2 of sensors 2a, 2b, 2c on board the aircraft, these sensors for example being radioaltimeters, view acquisition sensors in different spectral bands (visible, near-infrared, etc.), radio sensors, surveillance radars, combat radars, having imaging or weather modes. It is understood that the sensors 2a, 2b, 2c are shown only as an example, and that any number of sensors can be used.

The sensors are suitable for transmitting data relative to the environment of the aircraft at the moment when the flight is performed, to a mission system 4 and, as an optional addition, directly to an operator terminal 6 via a communication module 8 of said operator terminal.

The operator of said terminal in this example is the pilot of the aircraft.

The communication module 8 is for example a wired communication module, and in this case the data sent by the sensors 2 are sent by said wired link, according to an appropriate communication protocol.

Alternatively, the communication module 8 is suitable for communicating according to a radio communication protocol, optionally secured by encryption methods.

The system 1 also includes a flight management system or FMS 5, which cooperates with the mission system 4 and generates a reference trajectory of the aircraft, denoted T_{Ref}, in particular as a function of information provided by the sensors 2.

In addition, additional information 9, sent by a radiocommunication means from a control center or another unit (irrespective of its location: airport, ground, surface, etc.) is also received and used.

The operator terminal 6 can either be on board the carrier, or located in a control and command center on the ground. It includes a central processing unit 10, or CPU, for example an electronic processor, able to execute computer program instructions when the terminal 6 is powered on, one or several display modules 12, and a man-machine interface (MMI) 14 for entering commands from an operator, which is for example a module for entering tactile commands. Alternatively, the interface 14 for entering commands is integrated with a tactile display screen 12.

It also includes an electronic memory unit 16 suitable for storing data and executable code instructions.

The functional blocks 8, 10, 12, 14 and 16 are interconnected, for example via a communication bus.

A mission plan including several mission phases is generally developed before the mission, and is received by the mission system 4 either by a datalink, or by a file transfer means (of the memory card type, or even USB key).

The operator terminal 6 is suitable for receiving mission commands 18, via the command entry interface 14. For example, the commands 18 allow an operator, pilot of the aircraft, to make tactical choices to command the initialization of a mission type or a change of mission phase.

A tactical choice for example corresponds to a choice of one alternative from among several proposals from the system (avoid or engage a threat, for example, or choice of one trajectory from among several proposals corresponding to different standard profiles of pilots). A change of mission phase can be made automatically, for example when the aircraft reaches a predefined point, or on command from the pilot. For example, if the current mission phase consists of looking for a ship in trouble, the pilot can ask to change the mission phase when the sought ship has been found.

A mission plan includes several phases, which are for example chosen by the operator from among a set of predetermined phases.

For example, several phases can be distinguished:
A) transit phase, during which the aircraft moves between a point A and a point B;
B) search and observation phase, during which the aircraft performs an observation of a search zone, to be traveled according to a given travel pattern;
C) stationary flight phase, during which the aircraft must position itself above a target zone, and keep the current position;
D) freight drop phase, during which an appropriate drop zone must be determined and the aircraft kept in that position.

Of course, the list of mission phases A), B), C), D) given above is not exhaustive.

Each mission phase corresponds to a specific objective, and therefore different flight constraints may apply depending on the current type of mission phase.

In one advantageous embodiment, the display type of the trajectory of the aircraft on a display module 12 of the operator terminal 6 is chosen as a function of the mission phase, as explained in detail below. Thus, the most appropriate display relative to the objectives of the mission phase and the associated constraints is chosen.

In the illustrated embodiment, the operator terminal 6 is connected to a device 20 for flying the aircraft. This flying device 20 is suitable for receiving guiding instructions of the operator terminal 6 and applying them, in a known manner, to modify the trajectory of the aircraft, as a function of accessibility zones defined as a function of constraints associated with the mission phases.

In particular, the operator terminal according to the invention is suitable for warning the pilot (for example by raising an alert) if there is a risk deemed significant that one of the constraints associated with the current mission phase is not respected.

In one embodiment, the flying device 20 incorporates an automatic pilot device.

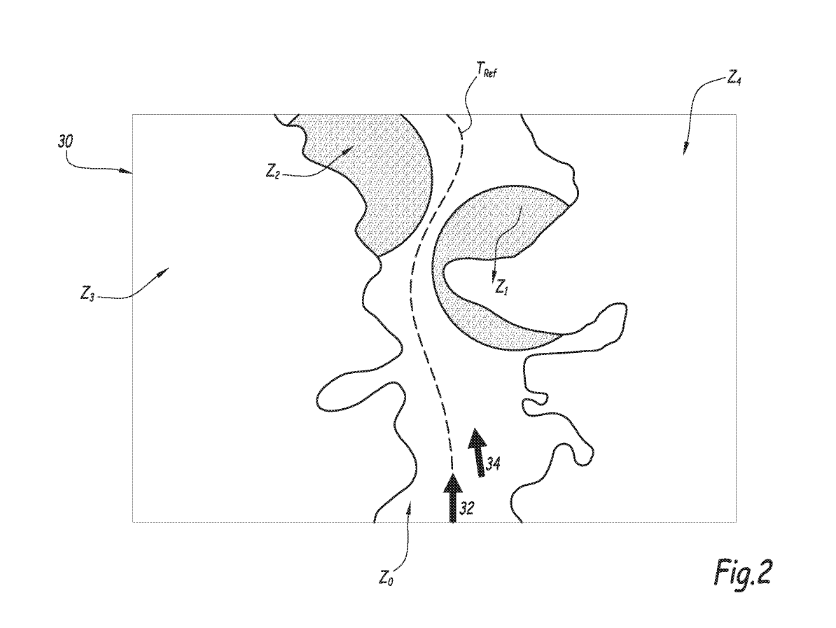

FIG. 2 schematically illustrates a display window 30 of the display module 12 of the operator terminal 6.

In this window 30 is displayed, in a first display mode that is the vertical display mode, above the overflown terrain, the reference trajectory T_{Ref} of the aircraft supplied by the FMS 5.

The display comprises a first graphic symbol 32, which is an arrow in this example, indicating the current position POS of the flown aircraft and the direction of flight of the aircraft.

Furthermore, the display also comprises, optionally and depending on the situation, a second graphic symbol 34, which is also an arrow in this example, indicating the current position POS_E of a second aircraft, crewmember accompanying the flown aircraft, and the direction of flight of said second aircraft. If applicable, the positions of several accompanying aircraft are displayed.

Several accessibility zones Z₀, Z₁, Z₂, Z₃, Z₄ are displayed, the reference trajectory T_{Ref} having an intersection with at least one of the displayed zones, the other zones being located in front of the current position of the aircraft, and contained in the zone (the expanse of which is adjustable by the operator) to which the pilot is paying attention. Several zones are shown, corresponding to the zones where, around the current altitude of the aircraft, the different types of constraints present near the reference trajectory and the current position of the aircraft are applicable (for example: the zones in which the terrain is close to the current flight level of the aircraft or the range of the known enemy weapons systems).

The displayed accessibility zones are two-dimensional zones in this first display mode, but correspond to three-dimensional zones.

Spatial proximity here means that the considered distance is smaller than the relative positioning uncertainty of the two considered elements.

The accessibility level is chosen from among a predefined set of accessibility levels, at least equal to 3, so as to define accessible zones, zones to be avoided and inaccessible zones.

According to an alternative, the accessibility level is chosen from among a predefined set of accessibility levels, at least equal to 2: accessible and inaccessible.

The accessibility level of an accessible zone is higher than the accessibility level of an inaccessible zone.

Alternatively, several accessibility levels, also including intermediate accessibility levels, are also defined.

For example, the accessible zones are zones for which the distance from any obstacle (relief or the like) is considered sufficient, there is no significant turbulence and no other significant danger relative to the current mission phase has been detected.

For example, inaccessible zones are obstacle zones (terrain or risk of collision with other aircraft), meteorological turbulence zones that prevent the adequate operation of on-board instruments.

The accessibility level is calculated from constraints associated with the mission phase, the calculation being done as a function of the mission phase.

Of course, the display is updated dynamically at regular time intervals, for example every 40 ms, which makes it possible to account for the environment of the aircraft, the commands from the operator and any change in mission phase.

The accessibility zones have a visual characteristic, for example the pattern or color, in connection with the accessibility level. For example, each predetermined accessibility level has an associated color, which allows the operator to distinguish the accessible zones from the prohibited zones very easily.

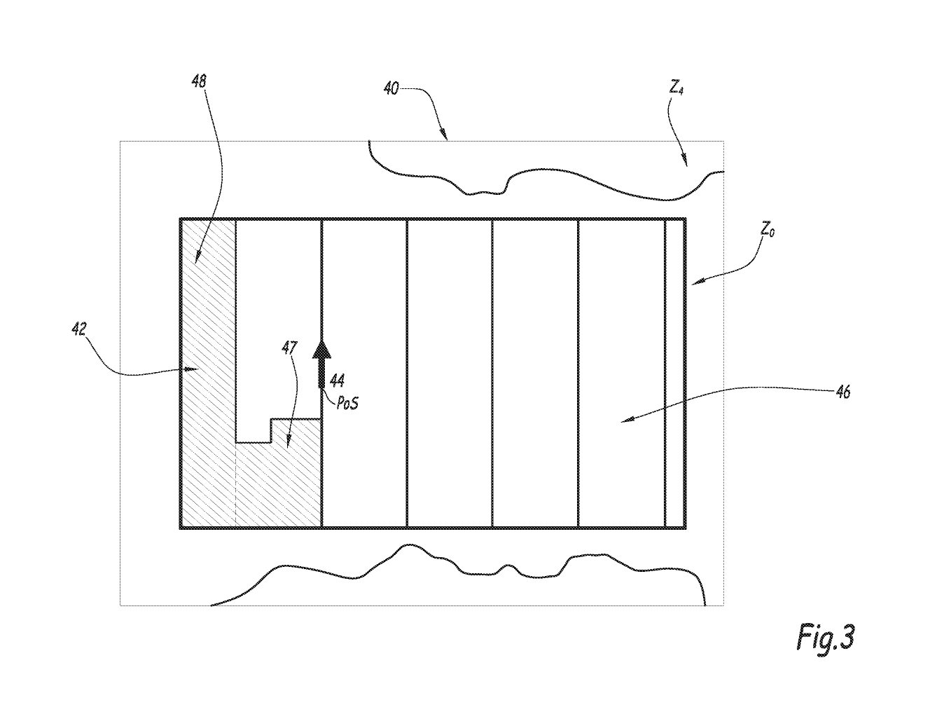

FIG. 3 schematically illustrates a display window 40 of the display module 12 of the operator terminal 6.

The display of FIG. 3 is a second display mode in particular suitable for a search and observation phase (phase B) according to a given travel pattern.

The display comprises a sub-window 42 that indicates the search perimeter to be overflown, and a first graphic symbol 44, which is an arrow in this example, indicating the current position POS of the flown aircraft and the direction of flight of the aircraft.

The search perimeter 42 is divided into portions 46 to be observed, and are also displayed, with a chosen display pattern, the portion(s) 48 already verified.

Additionally, is also displayed, with a chosen display pattern, the zone 47 being traveled and that is located in the detection perimeter of the on-board sensors 2.

Thus, the operator has a very clear vision of the search zone portion already traveled and portions remaining to be traveled, and therefore has all of the elements necessary to carry out the flight in the short term.

Additionally, superimposed on the display window 40, the accessibility zones Z₀, Z₄ are displayed, which in this example are respectively an accessible zone Z₀ and an inaccessible zone Z₄.

Like in the embodiment of FIG. 2, the displayed accessibility zones have a visual characteristic, for example the pattern or color, in connection with the accessibility level.

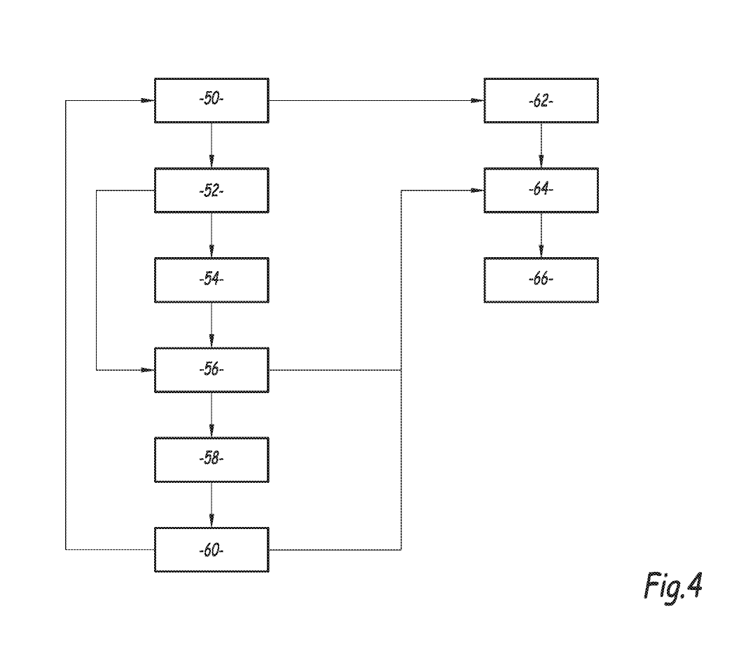

FIG. 4 is a flowchart of the main steps of a display method to help the mission flight of an aircraft according to one embodiment of the invention.

A first step 50 for obtaining the mission plan and the current mission phase is carried out. For example, it is the operator who indicates, via the man-machine interface, the mission type and the current mission phase. Alternatively, after indicating the mission type, the current mission phase is updated automatically, each mission type having a sequence of associated mission phases (mission plan) that is recorded beforehand.

The environment data are obtained in the environment data obtainment step 52. The environment data comprise data supplied by the on-board sensors, in particular the position data of the aircraft in a geolocation coordinate system, and data supplied by the navigation instruments, in particular data relative to the current dynamic of the aircraft, in particular comprising: the vertical speed, the vertical acceleration, the current airspeed, the heading. The on-board sensors also supply information (or parameters) on the environment, in particular regarding the other units present on the operating theater. Of course, other parameters measured to help fly the aircraft are also usable.

Additionally, information received from a ground control center and useful for flying complete the environment data, for example information relative to other aircraft located nearby.

These parameters are, in a known manner, supplied to mission systems, which extract the applicable constraints therefrom for conducting the flight (as a function of the state of advance of the mission plan and the state of the on-board systems). The FMS uses these constraints to calculate a reference trajectory T_{Ref} of the aircraft, obtained in step 54.

In the following step 56, a three-dimensional envelope Env_AR is determined of a short-term predicted trajectory, as a function of the state (position and dynamic) of the aircraft, the reference trajectory T_{Ref}, data relative to the current dynamic and the state of the commands.

Here, dynamic of the aircraft refers to its speed vector and acceleration characteristics.

Indeed, when the automatic pilot is not used and the pilot flies manually, or external elements (in particular the wind) cause the aircraft to deviate, the latter does not exactly follow the reference trajectory T_{Ref} calculated by the FMS.

The three-dimensional envelope Env_AR is a volume surrounding the calculated predicted trajectory, in which it is considered that the aircraft has a high likelihood of moving (this likelihood level corresponds to the acceptable rate of non-detection of dangerous situations in the context of the mission).

This envelope Env_AR is discretized in step 56, for example it is modeled by a set of nodes Nᵢ, each node Nᵢ being defined by a triplet (Xᵢ, Yᵢ, Zᵢ) of coordinates in a three-dimensional spatial coordinate system.

For each node Nᵢ, in step 58 one next obtains an associated applicable set of constraints. The applicable constraints are classified in two categories:
mandatory constraints, applicable in an absolute and binary manner: they are characterized by zones that are absolutely inaccessible in a given mission context;
relative constraints, the importance of which is assessed as a function of the current mission phase and other applicable constraints, for example the detection volumes of the known enemy sensors.

In the category of imperative constraints, there are for example obstacle avoidance constraints, for example as a function of the terrain (relief, buildings) or as a function of the presence of other aircraft.

In the category of relative constraints, there is for example the presence of meteorological turbulence: a given type of localized turbulence may have a greater impact in a stationary or freight drop flight phase than in a transit phase.

Some constraints may only be taken into consideration for certain mission phases. Alternatively, all relative constraints are taken into consideration in each mission phase, but with an associated weight coefficient, which may be equal to zero for certain mission phases.

For example, each node Nᵢ is associated with a constraint vector, the values of which are calculated as a function of the received information.

The constraints associated with a node are calculated as a function of the spatial position of the node relative to a zone, for example the altitude relative to the terrain, the position relative to a cloudy zone or by location relative to an estimated danger sphere with respect to an enemy unit.

In step 60, one next calculates a synthetic value of the different constraints applicable to a same node, for example by using a weighted sum. This synthetic value represents the accessibility level (or, conversely, danger level) associated with the geographical position corresponding to the considered node.

Furthermore, accessibility zones having a same accessibility level are calculated.

The level of the different constraints applicable to the areas around the position of the aircraft and the reference trajectory are displayed during a display step 64, superimposed on the reference trajectory.

Optionally, step 62 consists of determining the display mode most appropriate for the current task and the nature of the surrounding constraints.

For example: if the current task consists of navigating in formation, the system will display a top view showing the position of the members of the formation and the reference trajectory. Conversely, if the aircraft must look for a ship in a zone, the system will show the search zone, the zones in which the search has been done, and a set of trajectory segments for which the flight makes it possible to perform the search optimally. In both cases, the system will also show the various external constraints capable of influencing the performance of the flight, as previously described.

Additionally, the system alerts the pilot (step 66) when it becomes likely that one of the mission constraints will not be respected: if the envelope around the predicted trajectory contains a node whose synthetic accessibility level is too low, therefore below a predetermined threshold, or a node where a mandatory constraint is active (for example: the corresponding geographical position is below the ground level), then the pilot is alerted and the constraint for the problematic zone is characterized on the display module of the system by information intended for the pilot.

Preferably, the alert is embodied on the display module so as to draw the operators attention immediately, for example by a blinking display. Additionally, an audio alert is also raised.

The operator may then perform avoidance maneuvers, and owing to the display of indications, he has information to make tactical choices.

1. An operator terminal of an avionic system for flying an aircraft, suitable for use during a mission including a plurality of mission phases, the operator terminal comprising at least a display module and a computing device, implementing a flight management system suitable for determining a reference trajectory of the aircraft by incorporating at least one environment constraint,
wherein the operator terminal is suitable for displaying, on the display module,
the reference trajectory, a current position of the aircraft and a plurality of accessibility zones, at least one of the accessibility zones having an intersection with the reference trajectory, each of the accessibility zones having an associated calculated accessibility level,
the accessibility level being defined as a function of a current mission phase, a trajectory predicted from the reference trajectory and at least one flight constraint associated with the current mission phase.

2. The operator terminal according to claim 1, wherein the display is done according to a display mode chosen between a first display mode and a second display mode based on the current mission phase.

3. The operator terminal according to claim 1, wherein the accessibility zone has an associated display characteristic representative of the accessibility level.

4. The operator terminal according to claim 1, wherein the display also includes a first graphic symbol, indicating a current position of the flown aircraft and a direction of flight of the aircraft, and at least one second graphic symbol, indicating a position of a second aircraft.

5. The operator terminal according to claim 1, wherein the display includes an alert display when the predicted trajectory crosses a zone with an accessibility level below a predetermined threshold.

6. The operator terminal according to claim 1, wherein the display is refreshed dynamically at regular time intervals.

7. The operator terminal according to claim 1, wherein the constraints associated with the current mission phase include at least one mandatory constraint and at least one relative constraint associated with the current mission phase.

8. An avionic system for flying an aircraft suitable for use during a mission including a plurality of mission phases, the avionic system including an operator terminal connected to a device for flying the aircraft, characterized in that the operator terminal is according to claim 1.

9. A display method implemented by an operator terminal of an avionic system for flying an aircraft, suitable for use during a mission including a plurality of mission phases, the operator terminal comprising at least a display module and a computing device, implementing a flight management system suitable for determining a reference trajectory of the aircraft by incorporating at least one environment constraint,
comprising :
computing a predicted trajectory of the aircraft as a function of the reference trajectory, computing a plurality of accessibility zones, at least one of the accessibility zones having an intersection with the reference trajectory, each of the accessibility zones having an associated calculated accessibility level,
the accessibility level being defined as a function of a current mission phase and at least one flight constraint associated with the current mission phase,
displaying, on a module of the operator terminal, the reference trajectory, a current position of the aircraft and the accessibility zones.

10. The method according to claim 9, wherein the calculation of accessibility zones comprises:
computing a three-dimensional envelope of the predicted trajectory, and obtaining a plurality of nodes representative of the envelope,
for each node, obtaining a plurality of associated constraints, as a function of the current mission phase, and calculating an accessibility level by a sum weighted by weight coefficients associated with the constraints, at least part of the weight coefficients depending on the current mission phase.

11. The method according to claim 10, further including emitting an alert if the envelope contains a node whose calculated accessibility level is below a predetermined threshold.

12. The method according to claim 11, wherein the alert emission includes a display on the display module of an alert indicator and of information relative to at least one constraint applicable to the node.
